(19) United States
(12) Patent Application Publication
(10) Pub. No.: US 2013/0176328 A1
(43) Pub. Date: Jul. 11, 2013

(54) METHOD AND APPARATUS FOR PERSISTENT DISPLAY OF NAVIGATION CONTENT

(71) Applicant: Sethu Madhavan Pillai, Bangalore (IN)

(72) Inventor: Sethu Madhavan Pillai, Bangalore (IN)

(73) Assignee: NOKIA CORPORATION, Espoo (FI)

(21) Appl. No.: 13/517,011

(22) PCT Filed: Dec. 2, 2010
(86) PCT No.: PCT/FI10/50992

§ 371 Date: Aug. 28, 2012

(30) Foreign Application Priority Data
Dec. 25, 2009 (IN) 3189/CHENP/2010

(51) Int. Cl. G09G 5/14

(52) U.S. Cl. CPC G09G 5/14
USPC 345/592; 345/634

(57) ABSTRACT

An approach is provided for presenting persistent navigation content. Presentation of navigation information on a graphical user interface is caused, at least in part, on a device in a first format. The navigation information is generated according to a navigation application. Placement of the navigation application into a background process of the device is detected. Display of other content information in place of the navigation information on the graphical user interface based on the detection is caused, at least in part. Presentation of all or part of the navigation information in a second format is caused, at least in part. The second format is a persistent element overlaid on the other content information in the graphical user interface.

### BACKGROUND

Navigation systems and services have been widely deployed in both commercial and consumer sectors, as a standalone service or a service integrated with telecommunication services. Service providers (e.g., wireless, cellular, etc.) and device manufacturers are continually challenged to deliver value and convenience to consumers by, for example, providing compelling network services, applications, and content as well as user friendly devices. As such, important differentiators in the industry relate to the user interface of such devices. Traditionally, navigation applications monopolize the display and graphical user interface of such devices. However, as multitasking becomes more common, a device can sometimes change focus from the navigation application or the navigation application is switched to a background task as the user accesses other functions or applications of the device. This loss of focus or switching to a background task can cause the user to miss navigation instructions or other related information because generally navigation applications provide constant updates (e.g., current position, progress along a route, navigation instructions). As a result, service providers and device manufacturers face significant technical challenges in providing navigational information in a multitasking environment.

### SOME EXAMPLE EMBODIMENTS

Therefore, there is a need for an approach for presenting a persistent display of navigation content.

According to one embodiment, a method comprises causing, at least in part, presentation of navigation information on a graphical user interface of a device in a first format, the navigation information generated according to a navigation application. The method also comprises detecting placement of the navigation application into a background process of the device. The method further comprises causing, at least in part, display of other content information in place of the navigation information in the graphical user interface based on the detection. The method further comprises causing, at least in part, presentation of all or part of the navigation information in a second format. The second format is a persistent element overlaid on the other content information in the graphical user interface.

According to another embodiment, an apparatus comprising at least one processor, and at least one memory including computer program code, the at least one memory and the computer program code configured to, with the at least one processor, cause, at least in part, the apparatus to cause, at least in part, presentation of navigation information on a graphical user interface of a device in a first format, the navigation information generated according to a navigation application. The apparatus is also caused to detect placement of the navigation application into a background process of the device. The apparatus is further caused to cause, at least in part, display of other content information in place of the navigation information in the graphical user interface based on the detection. The apparatus is further caused to cause, at least in part, presentation of all or part of the navigation information in a second format. The second format is a persistent element overlaid on the other content information in the graphical user interface.

According to another embodiment, a computer-readable storage medium carrying one or more sequences of one or more instructions which, when executed by one or more processors, cause, at least in part, an apparatus to cause, at least in part, presentation of navigation information on a graphical user interface of a device in a first format, the navigation information generated according to a navigation application. The apparatus is also caused to detect placement of the navigation application into a background process of the device. The apparatus is further caused to cause, at least in part, display of other content information in place of the navigation information in the graphical user interface based on the detection. The apparatus is further caused to cause, at least in part, presentation of all or part of the navigation information in a second format. The second format is a persistent element overlaid on the other content information in the graphical user interface.

According to another embodiment, an apparatus comprises means for causing, at least in part, presentation of navigation information on a graphical user interface of a device in a first format, the navigation information generated according to a navigation application. The apparatus also comprises means for detecting placement of the navigation application into a background process of the device. The apparatus further comprises means for causing, at least in part, display of other content information in place of the navigation information in the graphical user interface based on the detection. The apparatus further comprises means for causing, at least in part, presentation of all or part of the navigation information in a second format. The second format is a persistent element overlaid on the other content information in the graphical user interface.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system including user equipment capable of persistently displaying navigation content, according to one embodiment;

FIG. 2 is a diagram of the components of user equipment that can display a graphical user interface to persistently display navigation content, according to one embodiment;

FIG. 3 is a flowchart of a process for persistently presenting navigation content on a graphical user interface, according to one embodiment;

FIG. 4 is a flowchart of a process for providing power savings while persistently presenting navigation content, according to one embodiment;

FIG. 5 is a flowchart of a process for updating persistently displayed navigation content, according to one embodiment;

FIGS. 6A-6D are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for persistent display of navigational content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

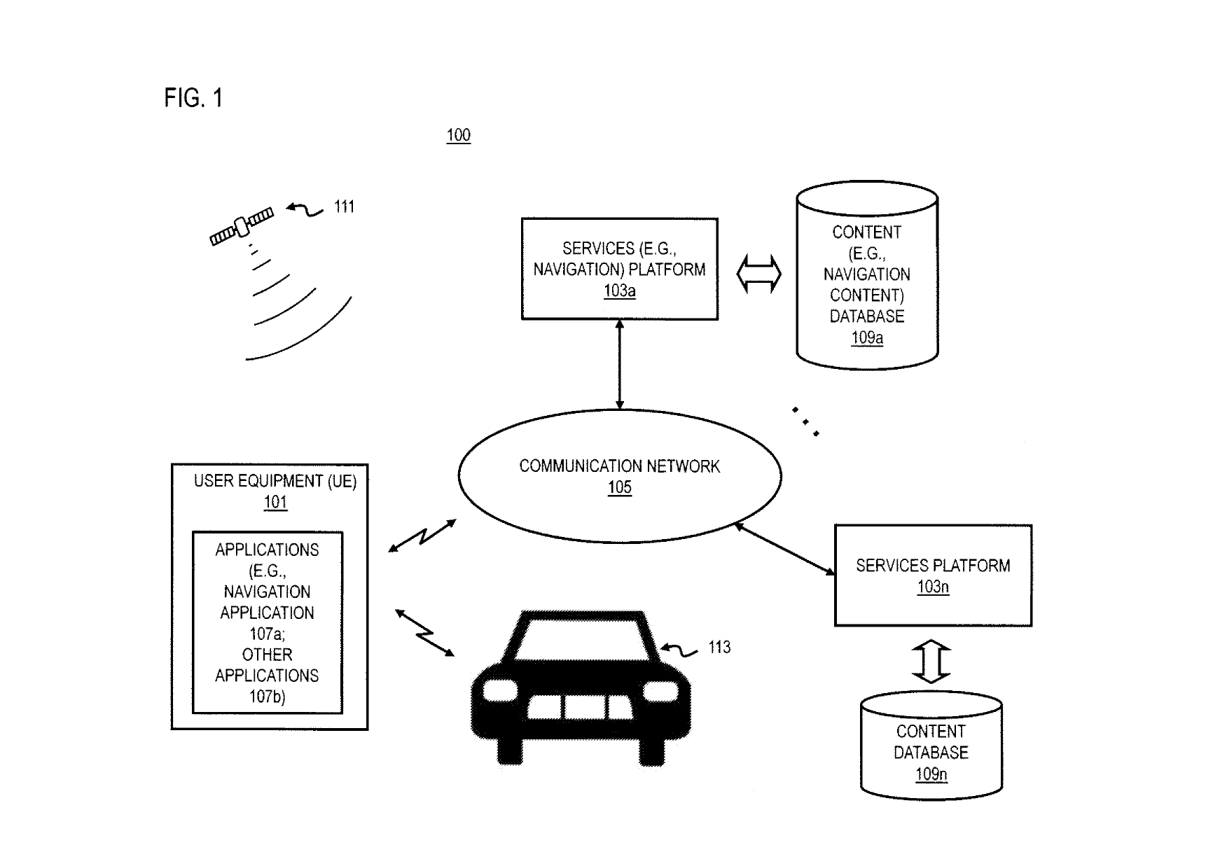

FIG. 1 is a diagram of a system including user equipment capable of persistently displaying navigation content, according to one embodiment. As previously noted, navigation systems have been extensively deployed in commercial and consumer sectors, including in devices that provide more services than merely navigation services. In many of these devices, it is inconvenient for a user to utilize these other services while utilizing the navigation service (e.g., because the navigation user interface of the device loses focus from the navigation information). A device may include applications for providing the navigation service as well as providing the other services. When other services are activated in place of the navigation service, the display of the navigation service switched to a presentation of the application providing the other services. Because aspects of the navigation application are not available in presentation while the other services are presented, the user is unable to view changes and/or updates to the navigational content. Further, it may be difficult for the user to navigate a graphical user interface (GUI) associated with the user's device to return to a presentation of the navigation application.

By way of example, the user may activate a navigation application on a device to receive navigational content (e.g., instructions) to a destination. The navigational content may be presented to the user using a GUI (e.g., via a map presentation). Then, the user takes advantage of the multitasking capabilities of the device and activates another application. The GUI switches to presenting the other application (e.g., changes the focus of the device to the other application) and moves the navigation application to a background processes. In this scenario, the user is unable to view navigational content while utilizing the other application. Thus, the user may lose focus of visual information associated with the navigation content while multitasking. In certain embodiments, voice navigation features of a device may be used to provide some navigation information (e.g., as audio prompts) when a visual GUI for the navigation is no longer displayed. However, audio information (e.g., spoken directions, alerts, prompts, etc.) may be easily missed by the user or may be otherwise unavailable. Further, once the device changes focus to another application, it can be difficult for the user to return to the navigation application and content. For example, the user may be required to activate an intermediary screen (e.g., a home screen, a task list, etc.) and select the navigation application. This process may be time consuming and inconvenient particularly when the user is driving or in an environment where the user cannot devote attention to operating the navigation features of the device.

To address these problems, a system 100 of FIG. 1 introduces the capability to persistently display navigation content even when the focus is no longer with the navigation application. In this manner, the UE 101 can display navigation content to the user while the user is utilizing other services or applications that present other content on a GUI of the UE 101 in place of the navigation information. In certain embodiments, a persistent display of navigation content is a user interface element (e.g., a floating display or widget) that presents navigation as an overlay on whatever content is currently displayed on the GUI of the UE 101. In this way, the system 100 advantageously enables the display of navigation information as the user multitasks or uses other functions of the UE 101. In one embodiment, the persistent user interface element or display may be movable and can be positioned on various parts of the GUI of the UE 101. Further, the persistent display may be semi-transparent to allow for viewing of information related to the other services while being able to view the navigation content at the same time.

In one embodiment, the UE 101 is any type of mobile terminal, fixed terminal, or portable terminal including a mobile handset, station, unit, device, navigation device, multimedia computer, multimedia tablet, Internet node, communicator, desktop computer, laptop computer, Personal Digital Assistants (PDAs), an embedded vehicle device, or any combination thereof. It is also contemplated that the UE 101 can support any type of interface to the user (such as “wearable” circuitry, etc.). The UE 101 can acquire data associated with providing services including the navigation services and the other services to the user from one or more services platforms 103a-103n (e.g., a navigation services platform 103a, and other services platforms 103n including messaging services, gaming services, music services, social services, a combination thereof, etc.) via a communication network 105. As noted above, multiple services can be utilized and multitasked on the UE 101. The services platforms 103a-103n can retrieve content from content databases 109a-109n associated with the services platforms 103a-103n. For example, a navigation services platform 103a may include map content in a navigation content database 109a. In certain embodiments, the UE 101 need not be connected to the communication network 105. In these embodiments, the applications 107 that can be executed on the UE 101 (e.g., a navigation application 107a, and other applications 107b such as a music application, a gaming application, etc.) can retrieve service related content from local storage (not shown) or from other attached content repositories.

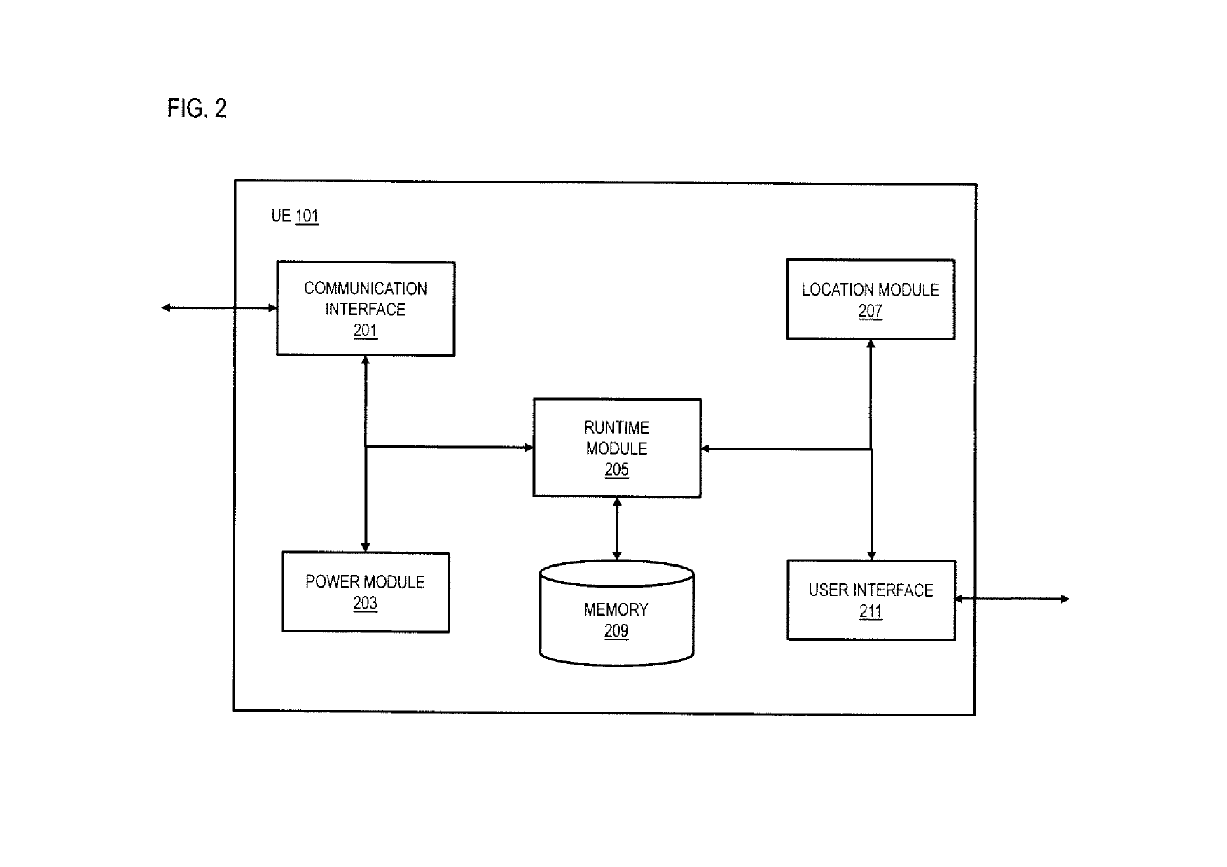

Further, the navigation application 107a may utilize location technology such as global positioning system (GPS) technology to determine navigational information. As such, the navigation application 107a may determine a location of the UE 101 by utilizing GPS satellites 111 as further detailed in FIG. 2. Moreover, the navigation application 107a may communicate with a vehicle 113 (e.g., a car, a bus, a train, a bike, a motorcycle, etc.) to retrieve additional information about the vehicle 113 for providing navigation content (e.g., vehicle telemetry data such as vehicle operating conditions, maintenance status, fuel levels, etc.). The vehicle 113 and the UE 101 may communicate in a variety of ways including wired communication (e.g., via a bus such as a universal serial bus (USB), parallel communications, etc.), wireless communication (e.g., Bluetooth®, wireless local area network, etc.) In one example, the navigation application 107a can provide an alert on the persistent display of the UE 101 when the vehicle 113 is in need of maintenance or service (e.g., the vehicle 113 has fuel below a certain threshold level). By using the persistent display, the navigation application 107a can advantageously provide an alert that is more likely to be noticed by the user. The navigation application 107a may then determine a location of a service supplier (e.g., a gas station) that can service the vehicle 113. For example, the alert can be presented to the user via the persistent display of navigation content. Such alerts can be very useful and important to the user.

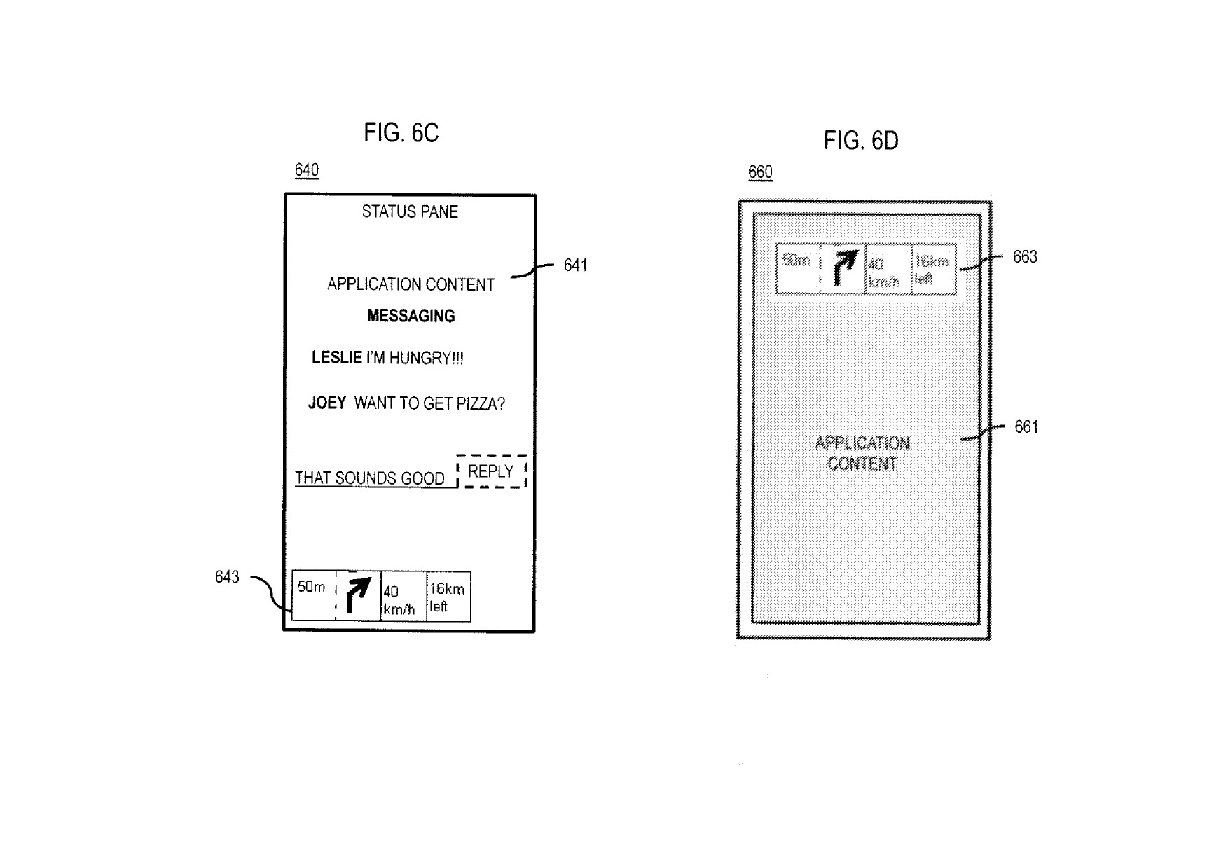

As shown in the user interfaces of FIGS. 6A-6D, in the persistent display, the UE 101 presents a persistent user interface element that remains continuously visible on the GUI of the UE 101 when the focus of the UE 101 shifts away from the navigation application 107a (e.g., when the application is placed into a background process). More specifically, when the navigation application 107a has the focus of the UE 101 (e.g., when the navigation application is in a foreground process), the navigation application 107a can display, for instance, a full-screen display of the navigation application 107a to showing navigation content in a first format (e.g., a format specifically tailored to full screen rendering such as providing a fully rendered map, directional elements, etc.). Then when the navigation application 107a is placed in a background process, a persistent user interface element (or view) can be displayed in a second format (e.g., a more compact format) that includes one or more portions of the navigation content. The more compact format advantageously enables the system 100 to display navigation content as an overlay on top of other content displayed in the GUI while minimizing the obscuring of the other content. As noted above, in certain embodiments, the persistent display or view is presented on a display continuously even as the focus changes from one application to another on the UE 101. In certain embodiments, the persistent display can additionally be generated and displayed as the navigation application 107a switches from one view (e.g., a map view of the application) to another view (e.g., a point-of-interest (POI) search view) that may not include the navigational content associated with the POI search view.

In one embodiment, the persistent user interface element or display may be a window (e.g., a floating window) covering a portion of the GUI of the UE 101 and may be movable and/or semi-transparent. As such, the user is able to view visual components of navigational content that may be important to the user (e.g., an upcoming turn, the speed of travel of the UE 101, distance to a destination, etc.) while utilizing other active applications 107 (e.g., non-navigational applications 107b). The navigational content may be continuously or periodically updated by the navigation application 107a executing as a background process. Further, while the persistent navigation display is presented to the user, the user may select the persistent display to activate the full screen display of the navigation application 107a and cause the navigation application 107a to become the active or foreground application. In certain embodiments, because the navigation application 107a is actively working in the background to determine at least the content in the persistent view, the navigation application 107a can more quickly switch to the full screen display.

Further, in certain embodiments, while the UE 101 presents the persistent view of the navigational content while utilizing another active application 107, the UE 101 can activate a power saving mode. In this mode, portions of a display of the UE 101 are darkened or shut off to save power. In this manner, the user can view the persistent view of the navigational content while saving power while utilizing the other active application 107. This may occur if the other active application 107b is idle for a predetermined time period, if the user provides input to select the power saving mode, if no input is received in a certain time period, etc. In certain embodiments, the power saving mode is dependent on the type of display technology used in the UE 101. For example, certain liquid crystal displays (LCDs) enable an application 107 to turn off certain pixels to conserve power. In this example, the UE 101 may shut down pixels unassociated with the persistent view of the navigation content to reduce power consumption. In another example, an organic light-emitting diode (OLED) may be utilized as a display. It is noted that unlike traditional LCD displays, OLEDs do not require a backlight to function because each OLED element is its own light source; therefore, darker shades draw less power than lighter shades. Thus, to save power using an OLED screen, the UE 101 may darken the screen for content displayed on the screen other than the persistent view of the navigational content. In other words, the system 100 can maintain the display of the persistent user interface element in a non-power saving state (e.g., in a normal brightness or active state) while placing the remaining parts of the screen (e.g., the portion displaying other content) in a power saving mode or state. In this manner, when the user is not actively utilizing the other application 107b, the user is able to view the content of the other application 107b while highlighting the persistent view of the navigational content.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101, navigation services platform 103a, other services platforms 103n, and vehicle(s) 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the applications 107 and the services platforms 103 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 2 is a diagram of the components of user equipment that can display a GUI to persistently display navigation content, according to one embodiment. By way of example, the UE 101 includes one or more components for persistently displaying navigation content while utilizing another active application 107b. It is contemplated that the functions of these components may be combined in one or more components or performed by other components of equivalent functionality. In this embodiment, the UE 101 includes a communication interface 201 to communicate with devices, a power module 203 to provide power to the UE 101 and control power management schemes, a runtime module 205 to execute applications 107, a location module 207 to determine the location of the UE 101, a memory 209, and a user interface 211 that may be utilized to display persistent navigation content to a user.

The communication interface 201 can be used to communicate with a services platform 103, other UEs 101, or devices such as a vehicle 113. Certain communications can be via methods such as an internet protocol, messaging, or any other communication method (e.g., via the communication network 105). In some examples, the runtime module 205 can send a query to a navigation services platform 103a via the communication interface 201. The navigation services platform 103a may then send a response back via the communication interface 201. Moreover, the UE 101 may communicate with other UEs 101 as a means for providing voice sessions or messaging services between UEs 101.

The power module 203 provides power to the UE 101. The power module 203 can include any type of power source (e.g., battery, plug-in, etc.). Additionally, the power module 203 can provide power to the components of the UE 101 including processors, memory, and transmitters, GPS technology, display screens, etc. The power module 203 may also be utilized by the runtime module 205 to control power flow and consumption to the components. For example, the power module 203 may be utilized to control the output to display screens during a power saving mode. As such, the power module 203 acts as a means for activating the power savings mode.

Further, the location module 207 can determine a user's location. The user's location can be determined by a triangulation system such as GPS, Assisted-GPS (A-GPS), Cell of Origin, or other location extrapolation technologies. Standard GPS and A-GPS systems can use GPS satellites 111 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 207 may also utilize multiple technologies to detect the location of the UE 101. Location coordinates can be determined using the location module 207. The location coordinates can be used for determining and providing navigational content to the user via the navigation application 107a. For example, location coordinates can be compared to location coordinates in a memory 209 to pinpoint the location of the user on a map. Moreover, the memory 209 may include POI information, maps, and other navigational content associated with the navigation application 107a. According to certain embodiments, POI information may include the location of and characteristics associated with one or more locations that may be of interest to a user (e.g., landmarks, stores, restaurants, friends, hotels, street corners, parks, gas stations, other goods and service providers, etc.). In an active navigation application view or the persistent view, the map may be displayed to the user via the user interface 211. Further, other navigational information may be determined based on the location information (e.g., routing to a destination, distance to a turn, etc.). In one example, multiple location coordinates taken in conjunction with time data can be utilized to determine a speed of travel of the UE 101. Further, the speed of travel may be utilized to determine the estimated time of arrival to a destination or a guidance point (e.g., a decision making point while traversing a route such as a turn or exit).

Moreover, the navigation application 107a may send, via the communication interface 201, the location information to a navigation services platform 103a that may be utilized to provide location services. For example, the navigation services platform 103a may be utilized to obtain information about the location of other devices (e.g., a device associated with a friend or other user) and/or the user's UE 101. In this manner, the navigation services platform 103a obtains and may track the movements of users (e.g., via storing the location coordinates of the user to a navigation content database 109a). In one embodiment, the user can set the navigation application 107a to request an alert from the navigation services platform 103a when certain people or points-of-interest are within a predetermined range (e.g., 50 meters) of the UE 101. The alert can cause the navigation application 107a to display the alert to the user on a persistent view of the navigation content while the user is utilizing other applications 107 of the UE 101.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface (e.g., keyboard), a microphone, etc. Moreover, the user interface 211 may be used to display content generated by the runtime module 205 while executing one or more applications 107. As previously mentioned, the screen of the user interface 211 may be dimmed or portions of the screen may be turned off as a means for power management. Further, the runtime module 205, providing a means for executing the navigation application 107a, may be generate content information according to the navigation application 107a to present on the screen (e.g., via a GUI) in a full screen format and/or one or more partial screen, persistent view formats. The user interface 211 can provide a means for altering the size, shape, and/or content provided by the presentation formats (e.g., by providing input to the runtime module 205 to set parameters associated with the formats).

Further, the memory 209 may be utilized to contain information associated with one or more applications 107 executing upon the runtime module 205. Additionally, when displaying a persistent view according to the navigation application 107a, the memory 209 can store navigation content, which can be updated by the runtime module 205. Moreover, the memory 209 can store data regarding different applications 107b, including instructions to execute the different applications 107b and content associated with the different applications 107b. Actively updating the persistent view content allows for quick switching from one of the different applications 107b to the navigation application 107a.

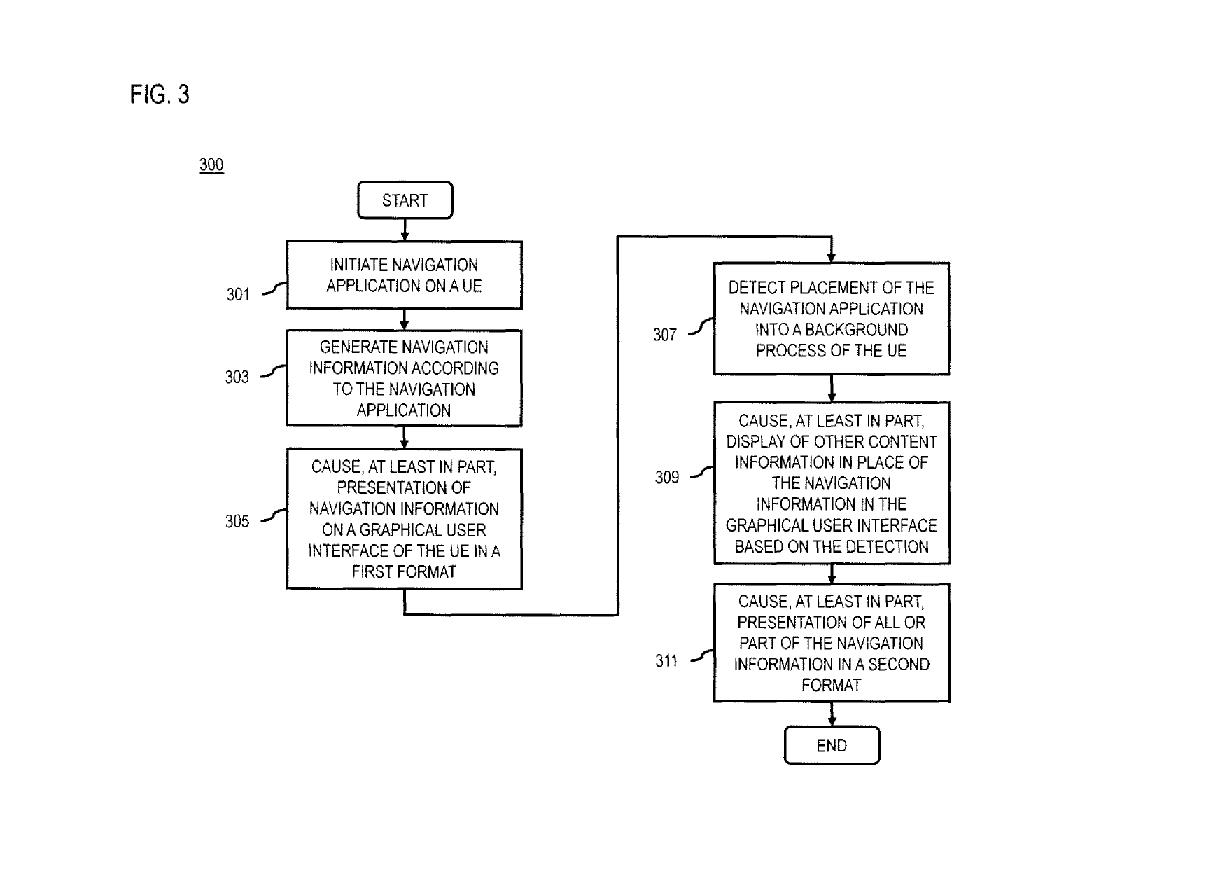

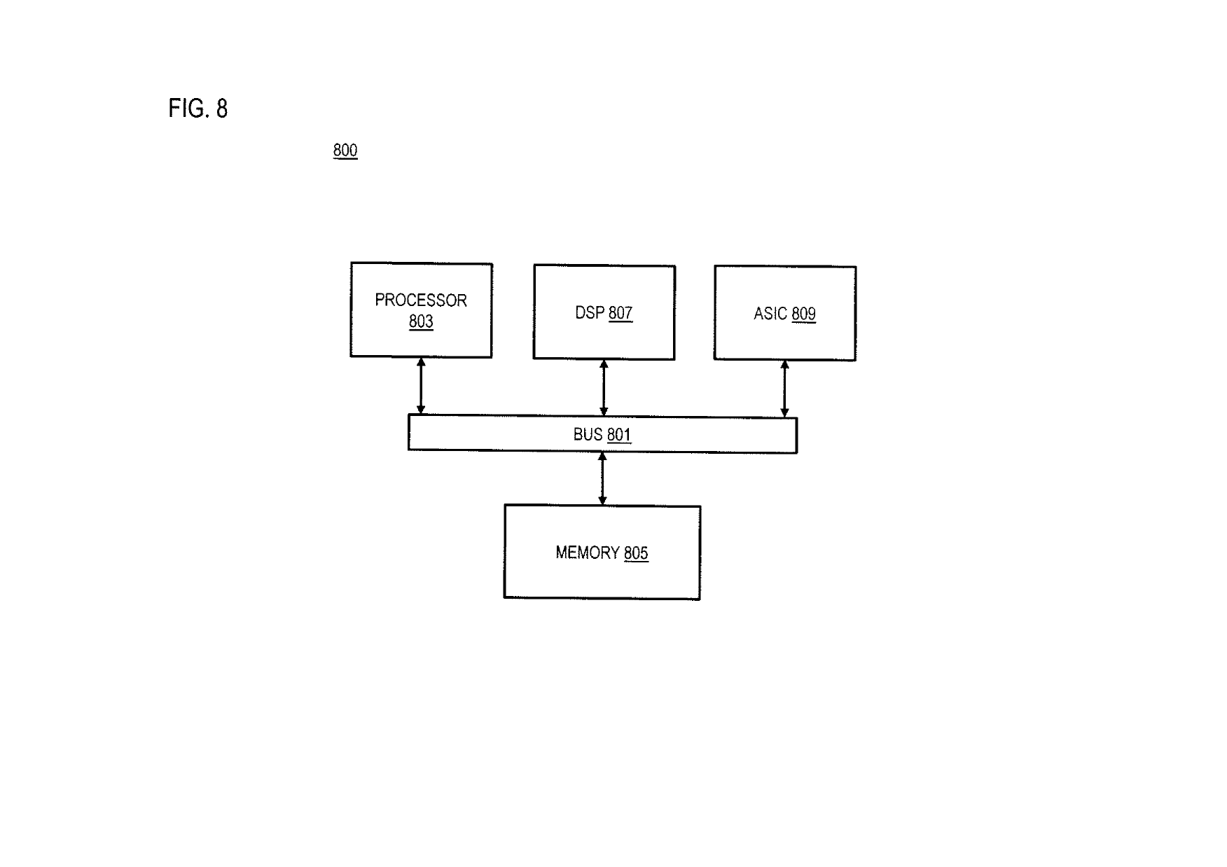

FIG. 3 is a flowchart of a process for persistently presenting navigation content on a GUI, according to one embodiment. In one embodiment, the runtime module 205 performs the process 300 and is implemented in, for instance, a chip set including a processor and a memory as shown FIG. 8. As such, the runtime module 205 and/or other components of the UE 101 may be means for performing the steps of process 300. In step 301, the runtime module 205 causes, at least in part, initiation of a navigation application 107a on a UE 101. The UE 101 can receive an input for initiating the navigation application 107a from a user interface 211. Further, the runtime module 205 of the UE 101 may be a means for causing, at least in part, initiation of the navigation application 107a.

Then, at step 303, the runtime module 205 generates navigation information according to the navigation application 107a. In certain embodiments, navigation information is data associated with the navigation application 107a that can be formatted to present navigational data to a user. The navigation information may include information associated with guiding the user along a path to a destination, information about points-of-interest nearby the UE 101, and other navigation related information. For example, the navigation information can include geographic information, a location of the UE 101 on a map, a distance to navigation objects (e.g., POIs, the destination, guidance points, friends, etc.) associated with locations, distance traveled from an origin (e.g., where a route begins) while navigating along the route, an estimated time of arrival to a navigation object, alerts associated with navigation objects (e.g., an alert that a fiend is within a predetermined range of the UE 101, an alert that the user's vehicle needs gas and a gas station is nearby, etc.), or a combination thereof. The generated navigation information may be selected by a user or set as defaults by the UE 101. In certain embodiments, the generated navigation information may include information retrieved from one or more navigation services platforms 103. The runtime module 205 can request navigation information (e.g., a route to a location, maps, etc.) from a first one of the navigation services platforms 103. If the first navigation services platform 103a does not include adequate information (e.g., does not have a recent map of the area or adequate POI information associated with the area), the UE 101 can request the information from a second navigation services platform 103a that may include different or additional data. As such, the components of the UE 101 can provide a means for generating navigation information according to the navigation application 107a.

Next, at step 305, the runtime module 205 causes, at least in part, presentation of navigation information on a GUI of the UE 101 in a first format. By way of example, the first format is displayed when the navigation application 107a has the focus (e.g., running in a foreground process) of the runtime module 107a and can include a full-screen display of the navigation information. The navigation information may be generated according to a navigation application 107a as indicated above. As such, the UE 101 includes means for causing, at least in part, presentation of the navigation information in the first format. In certain scenarios, the first format is a full screen format that covers a majority of the space available in a user interface 211 of the UE 101. In other scenarios, the first format can be a partial screen format that covers only an active portion of the user interface 211. In some embodiments, the first format includes rendered map information that may be presented via the user interface 211. As such, the first format may utilize UE resources to render and present the map content, which consumes a certain amount of power.

Next, the runtime module 205 can detect when the navigation application 107a loses focus or is otherwise placed into a background process of the UE 101 (step 307). Additionally or alternatively, the runtime module 205 can detect an activation of another program or application 107b to determine whether the navigation application 107a has lost focus on the GUI to become a background process. The UE 101 can utilize the runtime module 205 and other components of the UE 101 as means for detecting, on the UE 101, whether the navigation application 107a has been placed into a background process. As previously noted, the other application 107b or program that causes the navigation application 107a to lose focus may be an operating system application (e.g., a home screen, a file manager application, etc.) or a program application (e.g., a native application such as a browser, a web widget, utilizing a web runtime and portable web code, etc.) such as a game, a browser, a messaging application, a voice session application (e.g., for a phone call), a purchasing application, a time keeping application, a combination thereof, etc. By way of example, the runtime module 205 can detect the activation of the different application 107b when the UE 101 receives input or a request to transfer active status of the applications, based on an interrupt (e.g., based on an incoming phone call), based one or more set time periods (e.g., using idle parameters), or the like. When the other application 107b becomes active, the navigation application 107a is placed into the background process of the UE 101. In one exemplary embodiment, the other application 107b includes an application to support a voice communication session (e.g., a voice call) and the presentation of the different application 107b includes an identifier (e.g., a name, a phone number, etc.) of a contact associated with the communication session. Then, at step 309, the runtime module 205 causes, at least in part, display of other content information in place of the navigation information in the GUI based on the detected loss of focus. The other content information may be data associated with the other or different application 107b. Presentation of the content associated with the different application 107b may include any content normally produced and displayed on the user interface 211 by the application 107b. The runtime module 205 provides a means for causing, at least in part, presentation of the content associated with the different application 107b on the GUI of the UE 101.

Then, at step 311, the runtime module 205 causes, at least in part, presentation of all or part of the navigation information in a second format. The second format may be a persistent element or user interface element (e.g., a persistent view in the form of a window, a widget, a floating information display, etc.) overlaid on the other content information in the GUI. As such, the persistent element allows for the display of the navigation information to the user while the user is utilizing other functions of the UE 101. The presentation can be an automatic presentation based on the detected activation of the different application 107b or detection of the navigation application 107a being placed in the background. This may be a default setting on the navigation application 107a and a user may change the setting to deactivate the automatic use of presenting the navigation information in the second format. The portion of the navigation information may be selected by the user or preselected by the navigation application 107a according to parameters (e.g., default parameters for different scenarios) in the memory 209. Further, the portion of navigation information may be ordered in a customizable manner to present to the user. As such, the user may select the customizable parameters via the user interface. In one embodiment, the scenarios associated with default parameters (e.g., parameter that can be set by a manufacturer of the UE 101 or the developer of the navigation application 107a) may include a power saving mode scenario, a home screen scenario, a scenario associated with one or more known other applications 107b, or a combination thereof. These customizable and default parameters may additionally set a location to present the persistent element, e.g., an area unassociated with important content of the other content information. Further, as later detailed in the user interfaces of FIGS. 6A-6D, the persistent element may include one or more components as well as scrolling or iteratively updated content.

In one embodiment, scrolling or iteratively updating content associated with the components can enhance the user interface by making the various components visible or not visible based on user needs, what the user wants to follow, and/or the available display area. For example, the runtime module 205 may apply “programmed intelligence” to determine what components to make visible when there is insufficient display area in the persistent element to display all components or all user-selected components. Under this scenario, the runtime module 205 can apply one or more rules for determining which components to display. One rule, for instance, may determine the visibility of a particular component based on the component's update frequency. More specifically, it is noted that some components may include time-based content and/or may not be frequently updated, and therefore, need not be made visible in the persistent element all of the time. Accordingly, in one embodiment, the runtime module 205 may select which components to display based on either an associated static or variable content update interval. If a component has a static or less frequent content update interval, the runtime module 205 may not make the component visible in the persistent element by default (e.g., make the component always visible). Instead, the user can make the component visible by scrolling to the component in the persistent display. In this way, the component is visible only when the user desires to view the information.

In yet another embodiment, the user can select from the map view those components that the user wants to be presented in the persistent element. As noted above, the order of the components is changeable and can be customized by the user. Further, map elements (e.g., showing distance to destination, arrow, speed, etc.) may be structured as selectable components in the selection bar by, for instance, using a settings menu of the UE 101 or selecting the settings menu of the persistent element or the display of the UE 101.

As noted previously, the persistent view may include a window covering a portion of the GUI of the UE 101 and may be movable and/or semi-transparent. In addition, the persistent view may be continuously presented on the GUI (e.g., as an overlay) even though focus of the navigation application 107a is lost. As such, the persistent view can be presented even as one or more different applications 107b are brought into active view and the navigation application 107a is placed in a background process. Further, in certain embodiments, the navigation information of the navigation application 107a displayed in the persistent view according to the second format may be augmented or changed from the navigation information of the navigation application 107a presented in the first format. For example, the location of the user on a map in the first format may be one manner of displaying location navigation information. In the second format, the location information may be extrapolated to determine a speed of the UE 101, which can be formatted in the second format and presented in the persistent view. Further, sizes and shapes of visual indicators, such as icons may be different in the second format than in the first format. Further, the runtime module 205 determines navigation information, which may include location information of the UE 101, to update the navigation information. Moreover, even though the persistent view is not the active application, the runtime module 205 can update the navigation information in the second format based on the navigation information. In certain embodiments, the persistent view need not include complex rendering (e.g., map rendering) to provide for power savings on the UE 101.

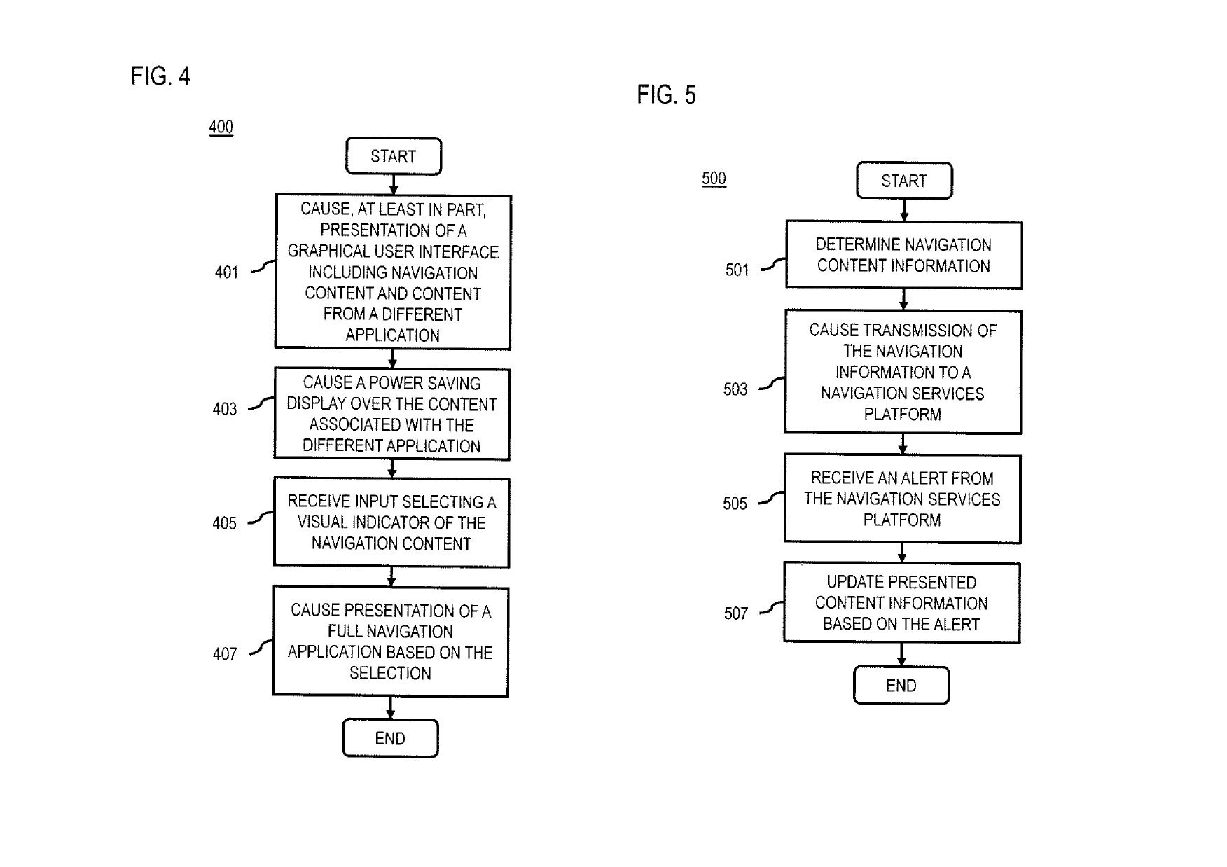

FIG. 4 is a flowchart of a process for providing power savings while persistently presenting navigation content, according to one embodiment. In one embodiment, the runtime module 205 performs the process 400 and is implemented in, for instance, a chip set including a processor and a memory as shown FIG. 8. As such, the runtime module 205 and/or other components of the UE 101 may be means for performing the process 300. In step 401, the runtime module 205 causes, at least in part, presentation of a GUI including navigation content and content from a different application. As noted above in the discussion of process 300, the navigation content may be part of navigation information of a navigation application 107a and be rendered and presented as part of a persistent view in the second format.

Then, at step 403, the runtime module 205 causes, at least in part, an activation of a power saving mode affecting the presentation of the different application 107b. Additionally or alternatively, the runtime module 205 detects the activation of the power saving mode. In certain embodiments, the activation is caused by an interrupt based on a timer or another application or inputs. As such, the activation can be based on a determination that the user is not actively using the different application 107b. For example, if the user does not utilize (e.g., provide input) to the UE 101 for a certain amount of time, the runtime module 205 can activate the power saving mode. In certain embodiments, the power saving mode is a screen saver. The screen saver may darken or shut off portions of a screen associated with the different application 107b. Moreover, the runtime module 205 can keep a normal presentation or a modified presentation (e.g., moving the display of the content, changing colors, etc.) of the navigation information presented as the persistent view in the second format. As such, the runtime module 205 causes, at least in part, maintenance of the persistent element in a non-power saving state, while the runtime module 205 causes, at least in part, activation of the power saving display mode for the other content information associated with the different application 107b. Thus, the user is able to receive the navigation information while in the power saving mode because the persistent user interface element displaying the navigation information remains active and visible. In another embodiment, the power saving mode need not include a screen saver while darkening the display of the different application 107b. Thus, the user can still see and utilize the different application 107b while saving power on the UE 101.

In certain embodiments, the UE 101 can receive an input selecting the persistent user interface element or a visual indicator displayed in the persistent user interface element (e.g., one or more sections of the persistent element or an icon associated with the navigation application 107a) to toggle the persistent element back to the full-screen display of the navigation application 107a (step 405). This input can occur while the UE 101 is in the power saving mode or when the UE 101 is in an active mode. In certain embodiments, the input can be the pressing of a key linked to the visual indicator. In other embodiments, the visual indicator can be selected using a touch screen interface or a click and scroll mechanism (e.g., mouse). Based on the input, the runtime module 205 causes, at least in part, presentation of the content information in the first format (e.g., the full-screen format) (step 407). Thus, the runtime module 205 causes, at least in part, return of the navigation application 107a to the foreground process. This process allows for a quick transition from the different application 107b being active to the navigation application 107a being active.

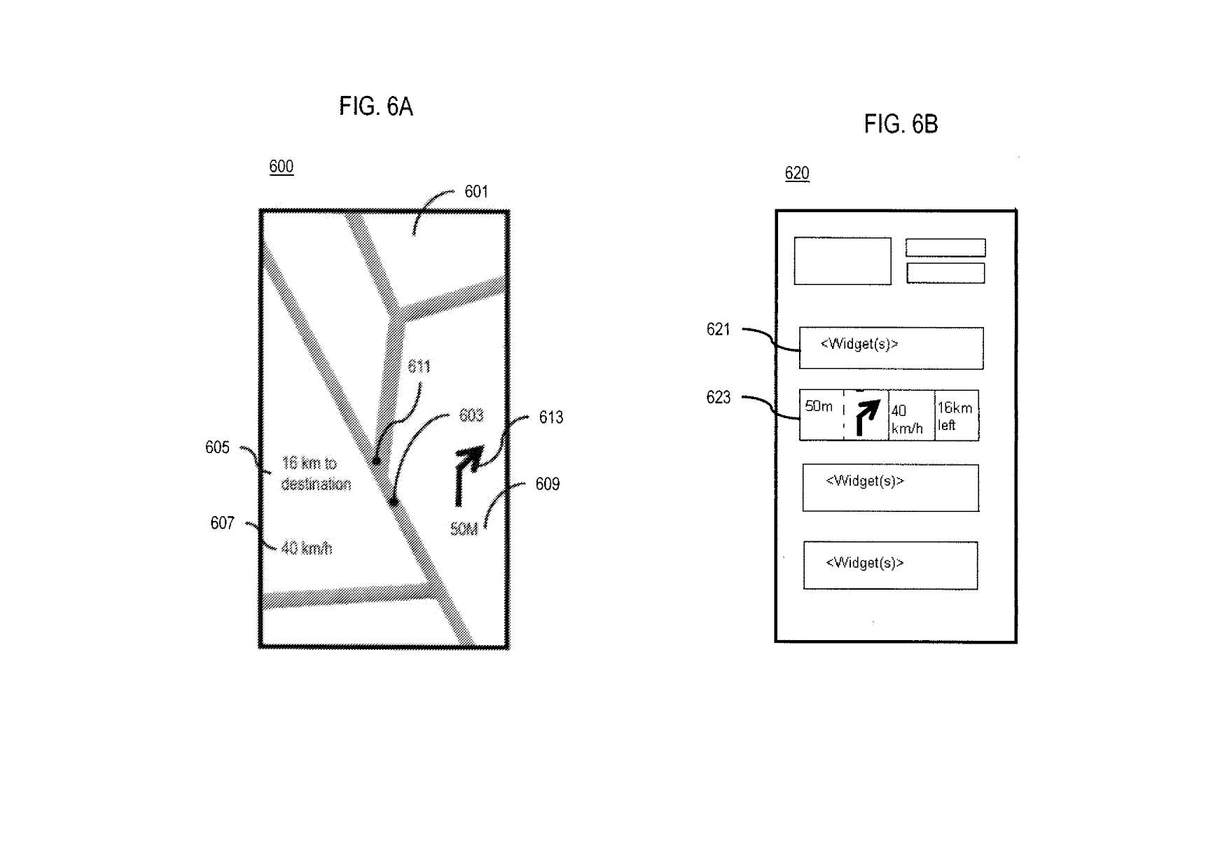

FIG. 5 is a flowchart of a process for updating persistently displayed navigation content, according to one embodiment. In one embodiment, the runtime module 205 performs the process 500 and is implemented in, for instance, a chip set including a processor and a memory as shown FIG. 8. As such, the runtime module 205 and/or other components of the UE 101 may be means for performing the steps of process 300. In step 501, the runtime module 205 can be caused to determine navigation information that may be used to update navigation information as used in the processes of FIGS. 3 and 4. The navigation information may include location information of the UE 101, routing information to a destination, map information, etc. This navigation information may be utilized to generate and update navigation information.

In one embodiment, the navigation application 107a utilizes a navigation services platform 103a to receive updated navigation information (e.g., updated locations of POIs, users, alerts, etc.). As such, the runtime module 205 causes, at least in part, transmission of location information associated with the navigation information to the navigation services platform 103a (step 503). The navigation services platform 103a can utilize that location information to retrieve information from a content database 109a associated with navigation information around the location of the UE 101. The navigational content database 109a may include information for tracking people (e.g., contacts of the user stored in a memory of the UE 101), landmarks, favorite places of the user, etc. The navigational content database 109a can also be customized to the user based on an account associated with the user or UE 101 on the navigation services platform 103a. In certain embodiments, the navigation application 107a need not utilize the services of the navigation services platform 103a and can generate the alerts based on content from a memory 209 of the UE 101. Then, when the UE 101 is within a predetermined range (e.g., 50 meters, 1 mile, etc.) of a point-of-interest (e.g., a person, a landmark, a red light traffic camera, etc.) selected based on criteria (e.g., settings set by the user), the UE 101 receives an alert from the navigation services platform 103a (or the alert can be generated by the runtime module 205) (step 505). Then, the runtime module 205 updates the navigation information in the second format (e.g., the persistent element) based on the alert (step 507). For example, when a friend is nearby, the runtime module 205 can alter the presentation of the persistent element to include the alert (e.g., a friend icon, the name of the friend, etc.). In certain embodiments, this information may be highlighted by using coloring schemes (e.g., turning that portion a contrasting or bright color from other information displayed), by flashing or blinking the information (e.g., blink faster when closer to a location associated with the alert), or the like.

Moreover, alerts may be utilized to provide customized information to the user. For example, the runtime module 205 may be connected (e.g., via a wired connection such as USB or wireless connection such as Bluetooth®) to a vehicle 113. The vehicle 113 can generate telemetry data for the user (e.g., an indication associated with low fuel, an indication associated with low oil or need for maintenance, etc.). The telemetry data can be sent to the UE 101. When the UE 101 receives the telemetry data, the runtime module 205 executing the navigation application 107a can generate a corresponding alert based on set criteria of the UE 101. By way of example, these criteria can be used to search for service POIs that can fulfill the needs of the alert (e.g., an alerts indicating a need for fuel can be serviced by a fuel POI such as a gas station). Then, when the UE 101 is within the range, an alert for the fuel is used to update the navigation information in the persistent element. As discussed previously, displaying alerts in the persistent element can make the alert more visible or accessible to the user. Thus the alert is presented to the user via a user interface 211. In another embodiment, the user may enter information in the UE 101 to request a reminder to go to certain locations or POIs based on the information. The information may include a reminder request based on geographical location, such as, a reminder request to go to a shopping center or grocery store to buy supplies from the store. When the runtime module 205 detects that the UE 101 is within range of a particular location (e.g., a particular store) or of a matching location (e.g., any grocery store), an alert may be sent and presented via the persistent navigation display.

FIGS. 6A-6D are diagrams of user interfaces utilized in the processes of FIGS. 3-5, according to various embodiments. User interface 600 includes an exemplary GUI of an active navigation application 107a in a full screen format. The user interface 600 may present a map 601, a location 603 of the UE 101 on the map, a distance to a routed destination 605, a speed 607 of the UE 101, guidance instructions (e.g., a distance to the next guidance point 609 such as a location 611 to take a turn or an exit), etc. Moreover, the user interface 600 may include icons 613 and other visual indicators to notify the user of guidance instructions. Further, the user interface 600 may include other display content not specifically shown, including formatted navigation information previously mentioned.

In the illustrated examples, a user of the UE 101 may wish to utilize the UE 101 to perform different functions other than the navigation application 107a. Thus, the user may activate a home screen application on a user interface 620 of FIG. 2B, according to one embodiment. The home screen application can display widgets 621 (e.g., programs and/or applications that may execute on the UE 101). Further, the home screen may include a display of navigation content according to the navigation application 107a in a first persistent view 623 of the navigation content. As previously noted, a persistent element such as a window or a floating display may be utilized to present the navigation content in the persistent view format. This first persistent view 623 may be updated by the navigation application 107a while the home screen application is executing. As shown, the first persistent view 623 may include distances to navigation objects such as the distance to the next turn, a visual indicator (e.g., an indicator associating the distance to a turn), a travel speed, and a distance to a destination according to a route. Additionally or alternatively, other navigation content can be displayed in the persistent view format. As noted above, the order and content may be customized and selected by the user of the UE 101, set to default values, selected based on predetermined selection criteria, etc. In certain embodiments, the selected content may be navigation content that may be less processor-intensive to calculate, which can save power for the UE 101. Further, additional navigation information may be displayed using user interface updating mechanisms to update the navigation content that may be presented on a persistent view (e.g., scrolling the information to provide more content, iteratively updating the content to switch the content displayed periodically, etc.).

Further, the user may utilize the UE 101 to perform other actions by activating another program application, such as a messaging application. A messaging application is displayed as active in the user interface 640 of FIG. 6C, according to one embodiment. Application content 641 can be utilized from the active program application. As such, the user may interact with the active messaging application. Further, the user interface 640 may additionally display the persistent view format of navigation content as previously described in a second persistent view 643. As shown, the second persistent view 643 may be moved to various locations on the user interface 640. The second persistent view 643 may be moved according to predetermined parameters or selected to be moved to other locations by the user. Further, the persistent view may include transparency features to allow the user to view additional application content of the active application.

Further, in certain embodiments, the user may be idle while utilizing the active other application 107b different from the navigation application 107a. The user interface 660 of FIG. 6D displays the UE 101 in a power saving mode, according to one embodiment. In this embodiment, the application content 661 may be dimmed, turned off, or otherwise be put into a power saving mode while a third persistent view 663 of the navigation content is persistently displayed on the user interface 660. As such, the third persistent view 663 may be displayed to the user while the user waits to utilize the other application 107b. As noted above in relation to persistent views, the third persistent view 663 may display navigation content using user interface updating mechanisms (e.g., scrolling the information to provide more content, iteratively updating the content to switch the content displayed periodically, etc.). Further, the third persistent view 663 displays four portions of navigation content, however, it is understood that more or less portions of navigation content may be displayed on the third persistent view 663 or other persistent views. Moreover, the portions may be partitioned and displayed in separate areas of the user interface 660. Further, these portions may be linked into one or more larger portions (e.g., two portions snapping together to create a single portion). As noted above, each of these portions may be customized by the user or preset using default navigation application 107a parameters.

According to the above approaches, user equipment 101 is able to display persistent navigational content to a user while the user performs other activities on the UE 101. As such, the user is able to view updates of navigational information while being able to multitask on the UE 101. Thus, the usability of navigational services is increased because the user can continuously have the navigation information on hand while multitasking. Further, the above approaches allow for the quick transfer of active applications from a different application to the navigation application 107a, thus allowing the user to quickly and conveniently utilize the navigation application 107a after the user is done with utilizing the different application. Further, the UE 101 may reduce energy consumption by utilizing a power saving mode associated with using the persistent view. Further, in certain embodiments, the durability of home or return keys of a user interface 211 of the UE 101 can be improved because there would be less need to press the home key because the user can quickly and conveniently switch to the navigation application 107a by selecting a visual indicator of the navigation content and need not return to a home screen before selecting and returning to the navigation application 107a.

The processes described herein for providing persistent display of navigation content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

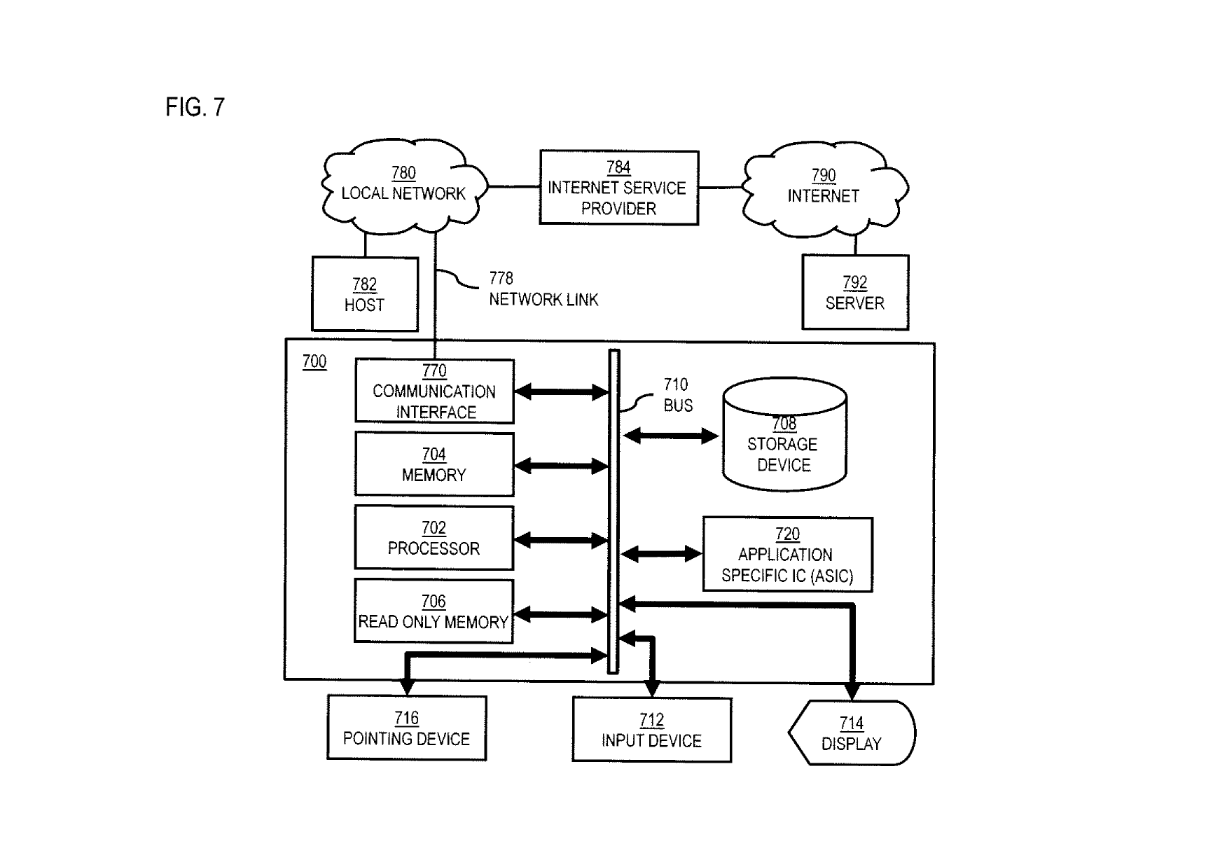

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to persistently display of navigation content as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, subatomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of persistently displaying navigation content.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to persistent display of navigation content. The computer program code is a set of instructions or statements providing instructions for the operation of the processor and/or the computer system to perform specified functions. The code, for example, may be written in a computer programming language that is compiled into a native instruction set of the processor.

The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for persistently displaying of navigation content. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for persistently displaying of navigation content, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for the UE 101.

The term “computer-readable medium” as used herein to refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708.

Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to persistently display of navigation content as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of providing persistent display of navigation content.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to persistently display navigation content. The memory 805 also stores the data associated with or generated by the execution of the inventive steps.

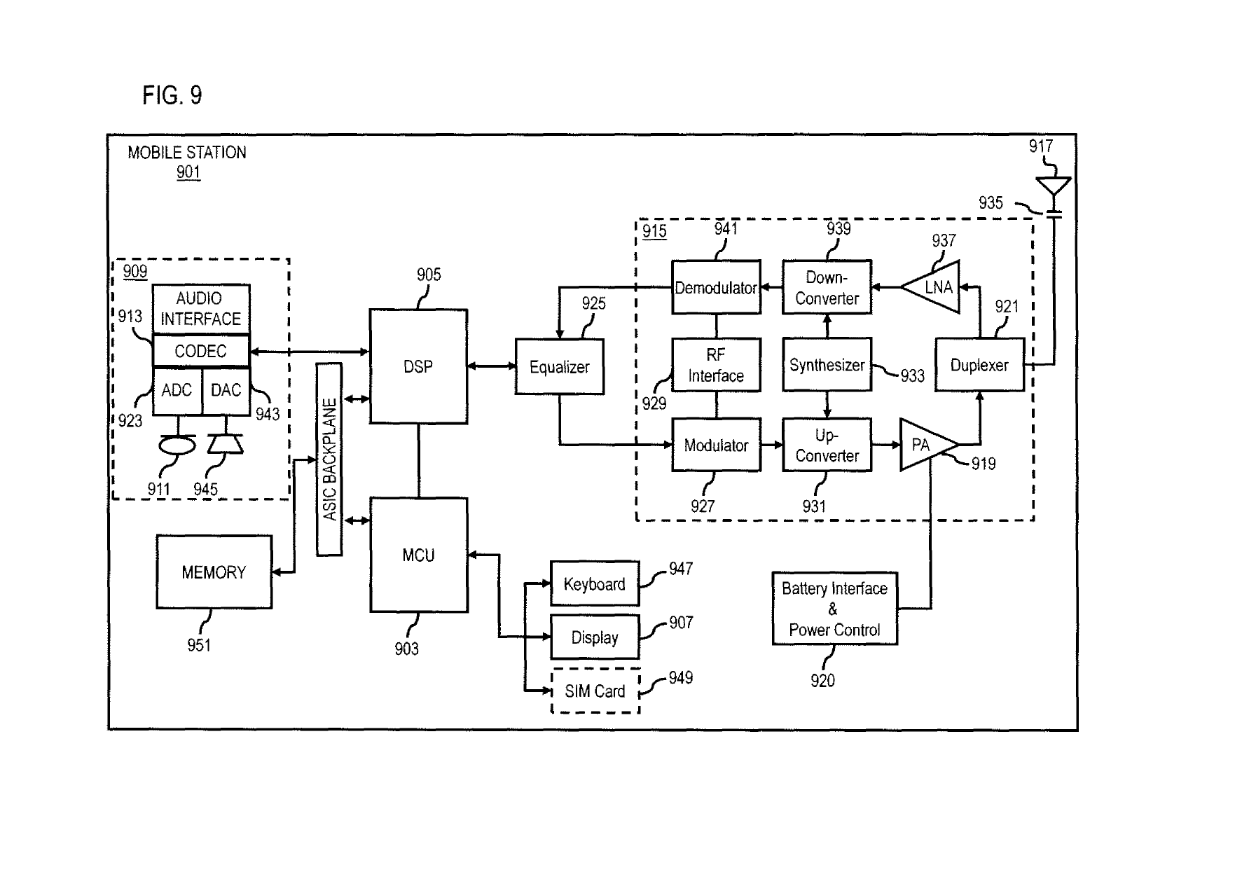

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of persistently displaying navigation content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of persistently displaying navigation content. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to persistently display navigation content. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-33. (canceled)

34. A method comprising:
causing, at least in part, presentation of navigation information on a graphical user interface of a device in a first format, the navigation information generated according to a navigation application;
detecting placement of the navigation application into a background process of the device;
causing, at least in part, display of other content information in place of the navigation information in the graphical user interface based on the detection; and
causing, at least in part, presentation of all or part of the navigation information in a second format, wherein the second format is a persistent element overlaid on the other content information in the graphical user interface.

35. A method of claim 34, further comprising:
receiving an input from the device for selecting the persistent element;
causing, at least in part, return of the navigation application to a foreground process; and
causing, at least in part, display of the navigation information in place of the other content in the graphical user interface based on the input.

36. A method of claim 34, wherein the second format includes a predetermined or user-specified set of the navigation information.

37. A method of claim 34, wherein the persistent element is a floating information display, a widget, or a combination thereof.

38. A method of claim 34, wherein the persistent element is transparent with respect to the other content information, movable relative to the other content information, or a combination thereof.

39. A method of claim 34, further comprising:
detecting activation of a power saving mode at the device;
causing, at least in part, maintenance of the persistent element in a non-power saving state; and
causing, at least in part, activation of a power saving display mode for the other content information.

40. A method of claim 34, further comprising:
generating an alert based, at least in part, on the navigation information; and
causing, at least in part, display of the alert in the persistent element.

41. A method of claim 40, further comprising:
receiving telemetry data from a vehicle interfaced with the device,
wherein the alert is generated based, at least in part, on the telemetry data.

42. An apparatus comprising:
at least one processor; and
at least one memory including computer program code,
the at least one memory and the computer program code configured to, with the at least one processor, cause the apparatus to perform at least the following,
cause, at least in part, presentation of navigation information on a graphical user interface of a device in a first format, the navigation information generated according to a navigation application;
detect placement of the navigation application into a background process of the device;
cause, at least in part, display of other content information in place of the navigation information in the graphical user interface based on the detection; and
cause, at least in part, presentation of all or part of the navigation information in a second format, wherein the second format is a persistent element overlaid on the other content information in the graphical user interface.

43. An apparatus of claim 42, wherein the apparatus is further caused, at least in part, to:
receive an input from the device for selecting the persistent element;
cause, at least in part, return of the navigation application to a foreground process; and
cause, at least in part, display of the navigation information in place of the other content in the graphical user interface based on the input.

44. An apparatus of claim 42, wherein the second format includes a predetermined or user-specified set of the navigation information.

45. An apparatus of claim 42, wherein the persistent element is a floating information display, a widget, or a combination thereof.

46. An apparatus of claim 42, wherein the persistent element is transparent with respect to the other content information, movable relative to the other content information, or a combination thereof.

47. An apparatus of claim 42, wherein the apparatus is further caused, at least in part, to:
detect activation of a power saving mode at the device;
cause, at least in part, maintenance of the persistent element in a non-power saving state; and
cause, at least in part, activation of a power saving display mode for the other content information.

48. An apparatus of claim 42, wherein the apparatus is further caused, at least in part, to:
generate an alert based, at least in part, on the navigation information; and
cause, at least in part, display of the alert in the persistent element.

49. An apparatus of claim 48, wherein the apparatus is further caused, at least in part, to:
receive telemetry data from a vehicle interfaced with the device,
wherein the alert is generated based, at least in part, on the telemetry data.

50. A computer-readable storage medium carrying one or more sequences of one or more instructions which, when executed by one or more processors, cause an apparatus to at least perform the following steps:
causing, at least in part, presentation of navigation information on a graphical user interface of a device in a first format, the navigation information generated according to a navigation application;
detecting placement of the navigation application into a background process of the device;
causing, at least in part, display of other content information in place of the navigation information in the graphical user interface based on the detection; and
causing, at least in part, presentation of all or part of the navigation information in a second format, wherein the second format is a persistent element overlaid on the other content information in the graphical user interface.

51. A computer-readable storage medium of claim 50, wherein the apparatus is caused, at least in part, to further perform:
detecting activation of a power saving mode at the device;
causing, at least in part, maintenance of the persistent element in a non-power saving state; and
causing, at least in part, activation of a power saving display mode for the other content information.

52. A computer-readable storage medium of claim 50, wherein the apparatus is caused, at least in part, to further perform:
generating an alert based, at least in part, on the navigation information; and
causing, at least in part, display of the alert in the persistent element.

53. A computer-readable storage medium of claim 52, wherein the apparatus is caused, at least in part, to further perform:
receiving telemetry data from a vehicle interfaced with the device,
wherein the alert is generated based, at least in part, on the telemetry data.
